(19) United States
(12) Patent Application Publication
(10) Pub. No.: US 2020/0367050 A1
(43) Pub. Date: Nov. 19, 2020

(54) WIRELESS COMMUNICATION METHOD, TERMINAL DEVICE AND NETWORK DEVICE

(71) Applicant: GUANGDONG OPPO MOBILE TELECOMMUNICATIONS CORP., LTD., Dongguan, Guangdong (CN)

(72) Inventor: Ning YANG, Dongguan, Guangdong (CN)

(21) Appl. No.: 16/764,780

(22) PCT Filed: Nov. 16, 2017
(86) PCT No.: PCT/CN2017/111370

§ 371 Date: May 15, 2020

(51) Int. Cl. H04W 8/24; H04W 72/04; H04W 28/02; H04L 5/00; H04W 72/10; H04W 76/27

(52) U.S. Cl. CPC H04W 8/24; H04W 72/048; H04W 28/0257; H04W 76/27; H04W 72/0453; H04W 72/10; H04L 5/0092

(57) ABSTRACT

Provided are a wireless communication method, a terminal device and a network device. The terminal device reports information of the maximum bandwidth capability supported thereby, and the network device can configure, for the terminal device and according to the information of the maximum bandwidth capability supported by the terminal device, a bandwidth part for transmitting data. The method includes: a terminal device sending the information of the maximum bandwidth capability supported by the terminal device to a network device.

### TECHNICAL FIELD

The present application relate to the field of communication, and more particularly, to a wireless communication method, a terminal device and a network device.

### BACKGROUND

In the fifth-generation (5-Generation, 5G) New Radio (NR) communication, the maximum channel bandwidth for low-frequency carrier is 100 MHz, and the maximum channel bandwidth for high-frequency carrier is 400 MHz. In 5G NR communication, the power consumption of the terminal device is very high. If the terminal device continues transmitting data according to the maximum channel bandwidth of the low-frequency carrier or high-frequency carrier, it may inevitably cause a large energy loss, thereby being unable to meet the requirements for energy consumption of terminal device in the 5G NR communication.

### SUMMARY

The embodiments of the present application provide a wireless communication method, a terminal device and a network device, in which the terminal device reports capability information of a maximum bandwidth supported by itself, and the network device can configure, for the terminal device, a bandwidth part for transmitting data according to the capability information of the maximum bandwidth supported by the terminal device. Accordingly, the terminal device can perform data transmission within a proper bandwidth range, thereby achieving the purpose of power saving.

According to a first aspect, embodiments of the present application provide a wireless communication method, including:

sending, by a terminal device, capability information of a maximum bandwidth supported by the terminal device to a network device.

Therefore, in the wireless communication method according to the embodiments of the present application, the terminal device reports capability information of a maximum bandwidth supported by itself, and the network device can configure, for the terminal device, a bandwidth part for transmitting data according to the capability information of the maximum bandwidth supported by the terminal device. Accordingly, the terminal device can perform data transmission within a proper bandwidth range, thereby achieving the purpose of power saving.

Optionally, according to an implementation manner of the first aspect, the method further includes:

sending, by the terminal device, indication information to the network device, the indication information being used for indicating a frequency range preferentially used by the terminal device and/or frequency priority information.

Furthermore, the terminal device reports indication information being indicative of the frequency range as preferentially used and/or the frequency priority information, such that the network device can configure, for the terminal device, the bandwidth part for transmitting data according to the capability information of the maximum bandwidth supported by the terminal device as well as the frequency range as preferentially used and/or the frequency priority information. Accordingly, the terminal device can perform data transmission within a proper bandwidth range, thereby achieving the purpose of power saving.

Optionally, according to an implementation manner of the first aspect, the method further includes:

receiving, by the terminal device, a bandwidth part (BWP) list and configuration information sent by the network device, the BWP list including at least one BWP, and a maximum bandwidth of the at least one BWP is less than or equal to the capability information of the maximum bandwidth supported by the terminal device, and the configuration information indicating a BWP for transmitting data in the BWP list; and

selecting, by the terminal device, a BWP from the BWP list for data transmission based on the configuration information.

According to a second aspect, embodiments of the present application provide a wireless communication method, including:

receiving, by a network device, capability information of a maximum bandwidth supported by a terminal device that is sent by the terminal device; and

configuring, by the network device, a bandwidth part (BWP) list and configuration information for the terminal device according to the capability information of the maximum bandwidth supported by the terminal device, the BWP list including at least one BWP, and a maximum bandwidth of the at least one BWP is less than or equal to the capability information of the maximum bandwidth supported by the terminal device, and the configuration information indicating a BWP for transmitting data in the BWP list.

Therefore, in the wireless communication method according to the embodiments of the present application, the terminal device reports capability information of a maximum bandwidth supported by itself, and the network device can configure, for the terminal device, a bandwidth part for transmitting data according to the capability information of the maximum bandwidth supported by the terminal device. Accordingly, the terminal device can perform data transmission within a proper bandwidth range, thereby achieving the purpose of power saving.

Optionally, according to an implementation manner of the second aspect, the method further includes:

receiving, by the network device, indication information sent by the terminal device, the indication information being used for indicating a frequency range preferentially used by the terminal device and/or frequency priority information;

the configuring, by the network device, a bandwidth part (BWP) list for the terminal device according to the capability information of the maximum bandwidth supported by the terminal device includes:

configuring, by the network device, the BWP list for the terminal device according to the capability information of the maximum bandwidth supported by the terminal device and the indication information.

Furthermore, the terminal device reports indication information being indicative of the frequency range as preferentially used and/or the frequency priority information, such that the network device can configure, for the terminal device, the bandwidth part for transmitting data according to the capability information of the maximum bandwidth supported by the terminal device as well as the frequency range as preferentially used and/or the frequency priority information. Accordingly, the terminal device can perform data transmission within a proper bandwidth range, thereby achieving the purpose of power saving.

Optionally, according to an implementation manner of the second aspect, the configuring, by the network device, a bandwidth part (BWP) list for the terminal device according to the capability information of the maximum bandwidth supported by the terminal device includes:

configuring, by the network device, the BWP list and the configuration information for the terminal device through radio resource control (RRC) dedicated signaling.

According to a third aspect, embodiments of the present application provide a terminal device, including any module or unit for performing the method according to the first aspect or any one of the optional implementation manners of the first aspect.

According to a fourth aspect, embodiments of the present application provide a network device, including any module or unit for performing the method according to the second aspect or any one of the optional implementation manners of the second aspect.

According to a fifth aspect, there is provided a terminal device. The terminal device includes a processor, a memory, and a communication interface. The processor is connected to the memory and the communication interface. The memory is configured to store instructions, the processor is configured to execute the instructions, and the communication interface is configured to communicate with other network elements under the control of the processor. When the processor executes the instructions stored in the memory, the execution causes the processor to execute the method according to the first aspect or any one of the optional implementation manners of the first aspect.

According to a sixth aspect, there is provided a network device. The network device includes a processor, a memory, and a communication interface. The processor is connected to the memory and the communication interface. The memory is configured to store instructions, the processor is configured to execute the instructions, and the communication interface is configured to communicate with other network elements under the control of the processor. When the processor executes the instructions stored in the memory, the execution causes the processor to execute the method according to the second aspect or any one of the optional implementation manners of the second aspect.

According to a seventh aspect, there is provided a computer storage medium, the computer storage medium stores program codes therein, and the program codes are used for instructing a computer to execute the method according to the first aspect or any one of the optional implementation manners of the first aspect.

According to an eighth aspect, there is provided a computer storage medium, the computer storage medium stores program codes therein, and the program codes are used for instructing a computer to execute the method according to the second aspect or any one of the optional implementation manners of the second aspect.

According to a ninth aspect, there is provided a computer program product including instructions which, when running on a computer, causes a computer to execute the method according to any aspect as described above.

### BRIEF DESCRIPTION OF THE DRAWINGS

FIG. 1 is a schematic diagram illustrating an application scenario of embodiments of the application.

FIG. 2 is a schematic flowchart illustrating a wireless communication method according to an embodiment of the application.

FIG. 3 is a schematic flowchart illustrating a wireless communication method according to another embodiment of the application.

FIG. 4 is a schematic diagram illustrating a BWP provided according to an embodiment of the application.

FIG. 5 is a schematic diagram illustrating a BWP provided according to another embodiment of the application.

FIG. 6 is a schematic diagram illustrating a BWP provided according to yet another embodiment of the application.

FIG. 7 is a block diagram illustrating a terminal device according to an embodiment of the application.

FIG. 8 is a block diagram illustrating a network device according to an embodiment of the application.

FIG. 9 is a block diagram illustrating a wireless communication device according to an embodiment of the application.

FIG. 10 is a schematic structural diagram illustrating a system chip according to an embodiment of the application.

### DETAILED DESCRIPTION

The technical solutions in the embodiments of the present application will be clearly and completely described below with reference to the drawings in the embodiments of the present application.

The technical solutions in the embodiments of the present application can be applied to various communication systems, for example, Long Term Evolution (LTE) system, LTE Frequency Division Duplex (FDD) system, LTE Time Division Duplex, TDD) system, Universal Mobile Telecommunication System (UMTS), Worldwide Interoperability for Microwave Access (WiMAX) communication system, 5G communication system and the like.

The terminal device in the embodiments of the present application may refer to user equipment (User Equipment, UE), access terminal, user unit, user station, mobile station, mobile site, remote station, remote terminal, mobile device, user terminal, terminal, wireless communication equipment, user agent or user device. The access terminal may be a cell phone, a cordless phone, a Session Initiation Protocol (SIP) phone, a Wireless Local Loop (WLL) station, a Personal Digital Assistant (PDA), handheld device and computing device having wireless communication function, other processing device, vehicle-mounted device, wearable device connected to a wireless modem, a terminal device in 5G network, a terminal device in the future evolved Public Land Mobile Network (PLMN) and the like, which are not limited in the embodiments of the present application.

The present application describes various embodiments in conjunction with an access network device. The network device in the embodiment of the present application may be a device for communicating with a terminal device. The network device may be an evolutionary base station (Evolutional NodeB, eNB, or eNodeB) in LTE system, or a radio controller in Cloud Radio access network (CRAN) scenario, or the access network device may be a relay station, an access point, an in-vehicle device, a wearable device, a Next Generation Evolutional NodeB (NG-eNB), an access network device (e.g., gNB) in 5G network, an access network device in the future evolved Public Land Mobile Network (PLMN), which are not limited in the embodiments of the present application.

The present application describes various embodiments with reference to a core network device. The core network device in the embodiments of the present application may be a device that communicates with an access network device. The core network device may be a 5G core network device, such as an Access and Mobility Management Function (AMF), or may be an Evolved Packet Core (EPC) device, such as a Mobility Management Entity (MME).

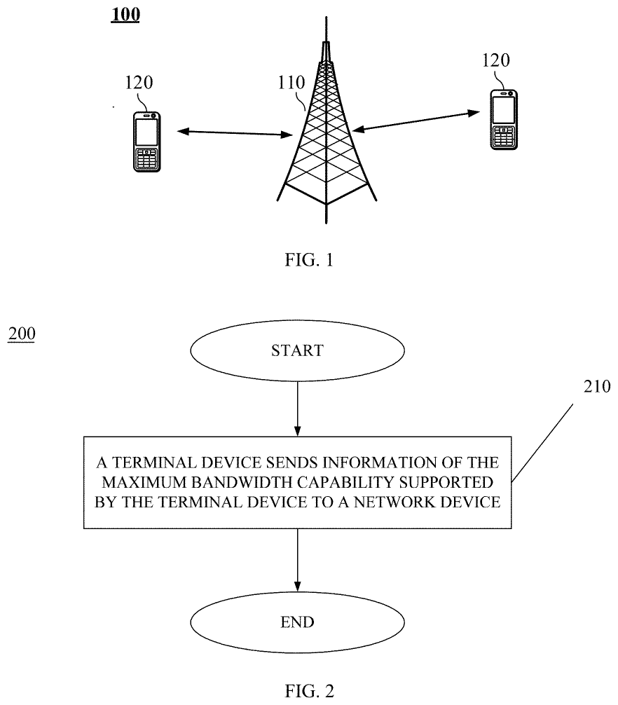

FIG. 1 exemplarily illustrates one network device and two terminal devices. Optionally, the wireless communication system 100 may include multiple network devices and the coverage range of each network device may include other numbers of terminal devices, which are not limited by embodiments of the application.

Optionally, the wireless communication system 100 may further include other network entities such as a network controller, a Mobility Management Entity (MME), and an Access and Mobility Management Function (AMF), which are not limited by embodiments of the application.

In addition, various aspects or features of the application may be implemented as a method, an apparatus, or an article of manufacture using standard programming and/or engineering techniques. The term “article of manufacture” as used in this application encompasses a computer program accessible from any computer-readable device, carrier, or medium. For example, the computer-readable medium may include, but not limited to, magnetic storage devices (for example, hard disks, floppy disks, or magnetic tapes, etc.), optical disks (for example, Compact Disc (CD), Digital Versatile Disc (DVD), etc.), smart cards and flash memory devices (for example, Erasable Programmable Read-Only Memory (EPROM), cards, sticks or key drives, etc.). In addition, the various storage medium described herein may refer to one or more devices and/or other machine-readable medium used for storing information. The term “machine-readable medium” may include, but not limited to, various medium capable of storing, containing, and/or carrying instruction(s) and/or data.

It should be understood that the terms “system” and “network” are often used interchangeably herein. The term “and/or” in this document is only a kind of association relationship describing related objects, which means that there can be three kinds of relationships, for example, A and/or B may refer to three cases: A exists alone, A and B exist simultaneously, and B exists alone. In addition, the character “/” in this article generally indicates that the related objects represent an “or” relationship.

FIG. 2 is a schematic flowchart illustrating a wireless communication method 200 according to an embodiment of the application. The method 200 is optionally appliable to the system as shown in FIG. 1, but is not limited thereto. The method 200 includes at least part of the following contents.

In 210, the terminal device sends capability information of a maximum bandwidth supported by the terminal device to the network device.

Optionally, the terminal device sends, before performing data transmission, the capability information of the maximum bandwidth supported by the terminal device to the network device.

Optionally, the terminal device sends, when initially accessing the network device, the capability information of the maximum bandwidth supported by the terminal device to the network device.

Optionally, the network device configures a bandwidth part (BWP) list and configuration information for the terminal device according to the capability information of the maximum bandwidth supported by the terminal device, the BWP list including at least one BWP, and a maximum bandwidth of the at least one BWP is less than or equal to the capability information of the maximum bandwidth supported by the terminal device, and the configuration information indicating a BWP for transmitting data in the BWP list.

Optionally, the BWP supports adjustable bandwidth of the terminal device to achieve the purpose of power optimization of the terminal device and, at the same time, may support frequency division multiple access (FDMA) multiplexing of different air interface access technologies.

Optionally, the method 200 may further includes:

the terminal device sends indication information to the network device, the indication information being used for indicating a frequency range preferentially used by the terminal device and/or frequency priority information.

For example, the terminal device preferentially uses the frequency range of 50 MHz to 100 MHz.

For another example, the terminal device preferentially uses a low frequency.

For another example, when the terminal device needs to perform an Ultra-Reliable and Low Latency Communication (URLLC) service, it preferably uses a high frequency.

Optionally, the network device configures the BWP list and the configuration information for the terminal device according to the capability information of the maximum bandwidth supported by the terminal device and the indication information.

Optionally, the BWP list may directly carry the configuration information.

Optionally, the method 200 further includes:

the terminal device receives the BWP list and the configuration information sent by the network device; and

the terminal device selects a BWP from the BWP list for data transmission based on the configuration information.

Therefore, in the wireless communication method according to the embodiments of the present application, the terminal device reports the capability information of the maximum bandwidth supported by itself, and the network device can configure, for the terminal device, the bandwidth part for transmitting data according to the capability information of the maximum bandwidth supported by the terminal device. Accordingly, the terminal device can perform data transmission within a proper bandwidth range, thereby achieving the purpose of power saving.

Furthermore, the terminal device reports indication information being indicative of the frequency range as preferentially used and/or the frequency priority information, such that the network device can configure, for the terminal device, the bandwidth part for transmitting data according to the capability information of the maximum bandwidth supported by the terminal device as well as the frequency range as preferentially used and/or the frequency priority information. Accordingly, the terminal device can perform data transmission within a proper bandwidth range, thereby achieving the purpose of power saving.

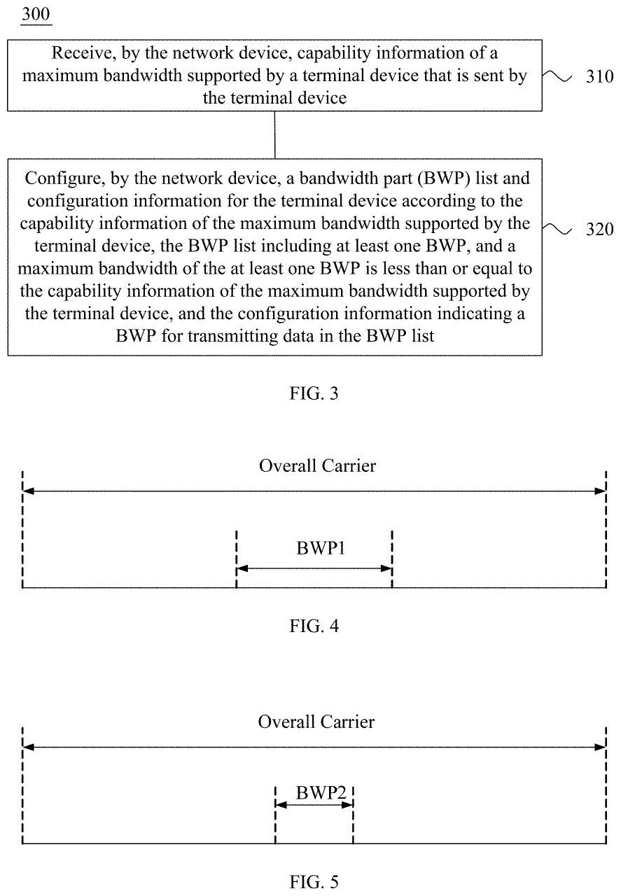

FIG. 3 is a schematic flowchart illustrating a wireless communication method 300 according to an embodiment of the application. The method 300 is optionally appliable to the system as shown in FIG. 1, but is not limited thereto. The method 300 includes at least part of the following contents.

In 310, the network device receives capability information of a maximum bandwidth supported by a terminal device that is sent by the terminal device.

In 320, the network device configures a bandwidth part (BWP) list and configuration information for the terminal device according to the capability information of the maximum bandwidth supported by the terminal device, the BWP list including at least one BWP, and a maximum bandwidth of the at least one BWP is less than or equal to the capability information of the maximum bandwidth supported by the terminal device, and the configuration information indicating a BWP for transmitting data in the BWP list.

Optionally, the method 300 further includes:

the network device receives indication information sent by the terminal device, the indication information being used for indicating a frequency range preferentially used by the terminal device and/or frequency priority information.

Optionally, the network device configures the BWP list for the terminal device according to the capability information of the maximum bandwidth supported by the terminal device and the indication information.

Optionally, the network device configures the BWP list and the configuration information for the terminal device through radio resource control (RRC) dedicated signaling.

For example, as shown in FIG. 4, the terminal device has a high rate, and the network device configures a relatively large bandwidth for the terminal device in the available bandwidth (Overall Carrier), BWP 1.

For another example, as shown in FIG. 5, the terminal device has a very low rate, and the network device configures a relatively small bandwidth for the terminal device in the Overall Carrier, BWP 2.

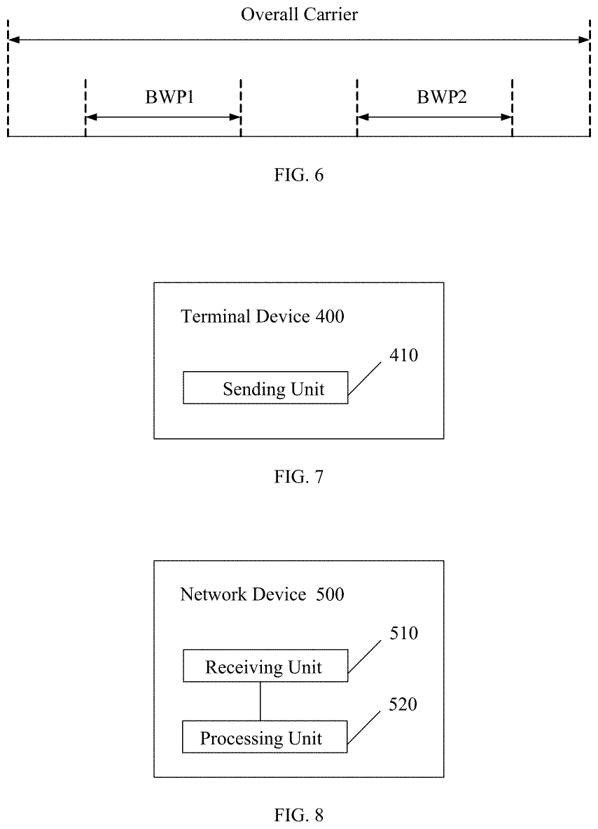

For another example, as shown in FIG. 6, if the terminal device supports a high rate or operates in a carrier aggregation (CA) mode, multiple BWPs, BWP 1 and BWP 2 may be configured.

It should be understood that the description in the wireless communication method 300 may refer to the related description of the corresponding steps in the wireless communication method 200, which will not be repeated here for the sake of brevity.

Therefore, in the wireless communication method according to the embodiments of the present application, the terminal device reports the capability information of the maximum bandwidth supported by itself, and the network device can configure, for the terminal device, the bandwidth part for transmitting data according to the capability information of the maximum bandwidth supported by the terminal device. Accordingly, the terminal device can perform data transmission within a proper bandwidth range, thereby achieving the purpose of power saving.

Furthermore, the terminal device reports indication information being indicative of the frequency range as preferentially used and/or the frequency priority information, such that the network device can configure, for the terminal device, the bandwidth part for transmitting data according to the capability information of the maximum bandwidth supported by the terminal device as well as the frequency range as preferentially used and/or the frequency priority information. Accordingly, the terminal device can perform data transmission within a proper bandwidth range, thereby achieving the purpose of power saving.

FIG. 7 is a block diagram illustrating a terminal device 400 according to an embodiment of the application. As shown in FIG. 7, the terminal device 400 includes:

a sending unit 410, configured to send capability information of a maximum bandwidth supported by the terminal device to a network device.

Optionally, the sending unit 410 is further configured to send indication information to the network device, the indication information being used for indicating a frequency range preferentially used by the terminal device and/or frequency priority information.

Optionally, the terminal device 400 further includes:

a receiving unit 420, configured to receive a bandwidth part (BWP) list and configuration information sent by the network device, the BWP list including at least one BWP, and a maximum bandwidth of the at least one BWP is less than or equal to the capability information of the maximum bandwidth supported by the terminal device, and the configuration information indicating a BWP for transmitting data in the BWP list; and

a processing unit 430, configured to select a BWP from the BWP list for data transmission based on the configuration information.

It should be understood that the above and other operations and/or functions of each module in the terminal device 400 according to the embodiment of the present application are respectively to implement the corresponding process of the terminal device in the method 200 of FIG. 2, which will not be repeated here for the sake of brevity.

FIG. 8 is a block diagram illustrating a network device 500 according to an embodiment of the application. As shown in FIG. 8, the network device 500 includes:

a receiving unit 510, configured to receive capability information of a maximum bandwidth supported by a terminal device that is sent by the terminal device; and

a processing unit 520, configured to configure a bandwidth part (BWP) list and configuration information for the terminal device according to the capability information of the maximum bandwidth supported by the terminal device, the BWP list including at least one BWP, and a maximum bandwidth of the at least one BWP is less than or equal to the capability information of the maximum bandwidth supported by the terminal device, and the configuration information indicating a BWP for transmitting data in the BWP list.

Optionally, the receiving unit 510 is further configured to receive indication information sent by the terminal device, the indication information being used for indicating a frequency range preferentially used by the terminal device and/or frequency priority information;

the processing unit 520 is further configured to configure the BWP list for the terminal device according to the capability information of the maximum bandwidth supported by the terminal device and the indication information.

Optionally, the processing unit 520 is further configured to configure the BWP list and the configuration information for the terminal device through radio resource control (RRC) dedicated signaling.

It should be understood that the above and other operations and/or functions of each module in the network device 500 according to the embodiment of the present application are respectively to implement the corresponding process of the network device in the method 300 of FIG. 3, which will not be repeated here for the sake of brevity.

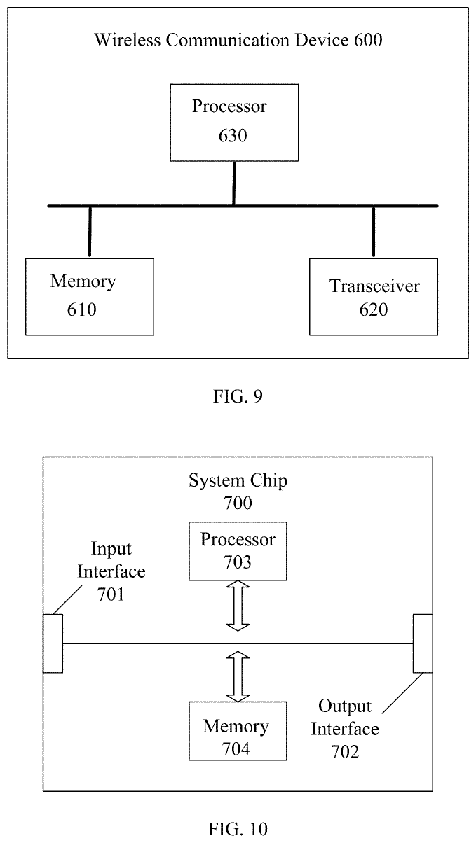

FIG. 9 illustrates a schematic block diagram of a wireless communication device 600 according to an embodiment of the present application. The device 600 includes:

a memory 610, configured to store a program including codes; and

a transceiver 620, configured to communicate with other devices.

The processor 630 is configured to execute program codes in the memory 610.

Optionally, the transceiver 620 is configured to perform specific signal transceiving under the driving of the processor 630.

Optionally, when the codes are executed, the processor 630 may also implement various operations performed by the terminal device in the method 200 of FIG. 2, which will not be repeated here for the sake of brevity. Accordingly, the device 600 may be a terminal device, for example, a mobile phone.

Optionally, when the codes are executed, the processor 630 may also implement various operations performed by the network device in the method 300 of FIG. 3, which will not be repeated here for the sake of brevity. Accordingly, the device 600 may be a network device, for example, a base station.

It should be understood that, in the embodiment of the present application, the processor 630 may be a Central Processing Unit (CPU), and the processor 630 may also be a general-purpose processor, a digital signal processor (DSP), an application-specific integrated circuits (ASIC), a field programmable gate array (FPGA) or other programmable logic devices, discrete gates, transistor logic devices, discrete hardware components or the like. The general-purpose processor may be a microprocessor, or the processor may be any conventional processor or the like.

The memory 610 may include a read-only memory and a random access memory, and provide instructions and data to the processor 630. A part of the memory 610 may further include a non-volatile random access memory. For example, the memory 610 may also store device type information.

The transceiver 620 may be configured to implement signal transmission and reception functions, such as a frequency modulation and demodulation function or an up-conversion and down-conversion function.

In the implementation process, at least one step of the above method may be completed by an integrated logic circuit of hardware in the processor 630, or the integrated logic circuit may complete the at least one step under the driving of instructions in a software form. Therefore, the wireless communication device 600 may be a chip or a chipset. The steps of the method disclosed in combination with the embodiments of the present application may be directly implemented by a hardware processor, or may be performed by a combination of hardware and software modules in the processor. The software module may be located in a mature storage medium such as a random access memory, a flash memory, a read-only memory, a programmable read-only memory, an electrically erasable programmable memory, a register, and the like. The storage medium is located in a memory, and the processor 630 reads information in the memory and completes the steps of the foregoing method in combination with its hardware. To avoid repetition, it will not be described in detail here.

FIG. 10 is a schematic structural diagram of a system chip 700 according to an embodiment of the present application. The system chip 700 shown in FIG. 10 includes an input interface 701, an output interface 702, a processor 703, and a memory 704 which may be connected through internal communication connecting lines. The processor 703 is configured to execute codes in the memory 704.

Optionally, when the codes are executed, the processor 703 implements the method executed by the terminal device in the method embodiments, which will be not repeated here for brevity.

Optionally, when the codes are executed, the processor 703 implements the method executed by the network device in the method embodiments, which will be not repeated here for brevity.

In the above embodiments, it may be implemented in whole or in part by software, hardware, firmware, or any combination thereof When implemented in software, it may be implemented in whole or in part in the form of a computer program product. The computer program product includes one or more computer instructions. When the computer program instructions are loaded and executed on a computer, the processes or functions according to the embodiments of the present application are wholly or partially generated. The computer may be a general-purpose computer, a special-purpose computer, a computer network, or other programmable device. The computer instructions may be stored in a computer-readable storage medium or transmitted from one computer-readable storage medium to another computer-readable storage medium, for example, the computer instructions may be transmitted from a website site, computer, server, or data center through a cable (e.g., coaxial cable, fiber optic, digital subscriber line (DSL)) or wirelessly (e.g., infrared, wireless, microwave and the like) to another website site, computer, server, or data center. The computer-readable storage medium may be any available medium that can be accessed by a computer or a data storage device such as a server, a data center, and the like that includes one or more available medium integrations. The available medium may be a magnetic medium (e.g., a floppy disk, a hard disk, a magnetic tape), an optical medium (e.g., a DVD), or a semiconductor medium (e.g., a solid state disk (SSD)).

It should be understood that, in the various embodiments of the present application, the size of the sequence numbers of the above processes does not mean the order of execution. The execution order of each process should be determined by its function and internal logic, and should not constitute any limitation to the implementation process according to the embodiments of the application.

Those skilled in the art can clearly understand that, for the convenience and brevity of the description, the specific working processes of the systems, devices, and units described above may refer to the corresponding processes in the foregoing method embodiments, and are not repeated here.

The above is only a specific implementation of the application, but the protection scope of the application is not limited thereto. Any person skilled in the art can easily think of changes or replacements within the technical scope disclosed in this application, which shall fall within the protection scope of the application. Therefore, the protection scope of the application shall be accordance with the protection scope of claims.

1. A wireless communication method, comprising:
sending, by a terminal device, capability information of a maximum bandwidth supported by the terminal device to a network device.

2. The method according to claim 1, further comprising:
sending, by the terminal device, indication information to the network device, the indication information being used for indicating a frequency range to be used by the terminal device and/or frequency priority information.

3. The method according to claim 1, further comprising:
receiving, by the terminal device, a bandwidth part (BWP) list and configuration information sent by the network device, the BWP list including at least one BWP, and the configuration information indicating a BWP for transmitting data in the BWP list; and
performing data transmission on the BWP for transmitting data in the BWP list indicated in the configuration information.

4.-6. (canceled)

7. A terminal device, comprising:
a transceiver, configured to send capability information of a maximum bandwidth supported by the terminal device to a network device.

8. The terminal device according to claim 7, wherein the transceiver is further configured to send indication information to the network device, the indication information being used for indicating a frequency range to be used by the terminal device and/or frequency priority information.

9. The terminal device according to claim 7, wherein,
the transceiver is further configured to receive a bandwidth part (BWP) list and configuration information sent by the network device, the BWP list including at least one BWP, and the configuration information indicating a BWP for transmitting data in the BWP list; and
the terminal device further comprises: a processing unit, configured to perform data transmission on the BWP for transmitting data in the BWP list indicated in the configuration information.

10. A network device, comprising:
a transceiver, configured to receive capability information of a maximum bandwidth supported by a terminal device that is sent by the terminal device; and
a processor, configured to configure a bandwidth part (BWP) list and configuration information for the terminal device according to the capability information of the maximum bandwidth supported by the terminal device, the BWP list including at least one BWP, and the configuration information indicating a BWP for transmitting data in the BWP list.

11. The network device according to claim 10, wherein,
the transceiver is further configured to receive indication information sent by the terminal device, the indication information being used for indicating a frequency range to be used by the terminal device and/or frequency priority information;
the processor is further configured to configure the BWP list for the terminal device according to the capability information of the maximum bandwidth supported by the terminal device and the indication information.

12. The network device according to claim 10, wherein the processor is further configured to configure the BWP list and the configuration information for the terminal device through radio resource control (RRC) dedicated signaling.

13. The method according to claim 1, further comprising:
receiving, by the terminal device, a bandwidth part (BWP) list and configuration information sent by the network device, the BWP list including at least one BWP, and the configuration information indicating a BWP for transmitting data in the BWP list; and
selecting, by the terminal device, a BWP from the BWP list for data transmission based on the configuration information.

14. The method according to claim 3, wherein maximum bandwidth of the at least one BWP is less than or equal to the capability information of the maximum bandwidth supported by the terminal device.

15. The terminal device according to claim 7, wherein,
the transceiver is further configured to receive a bandwidth part (BWP) list and configuration information sent by the network device, the BWP list including at least one BWP, and the configuration information indicating a BWP for transmitting data in the BWP list; and
the terminal device further comprises: a processing unit, configured to select a BWP from the BWP list for data transmission based on the configuration information.

16. The terminal device according to claim 9, wherein a maximum bandwidth of the at least one BWP is less than or equal to the capability information of the maximum bandwidth supported by the terminal device.

17. The network device according to claim 11, wherein the processor is further configured to configure the BWP list and the configuration information for the terminal device through radio resource control (RRC) dedicated signaling.

18. The network device according to claim 10, wherein a maximum bandwidth of the at least one BWP is less than or equal to the capability information of the maximum bandwidth supported by the terminal device.
